(19) United States
(12) Patent Application Publication
(10) Pub. No.: US 2021/0284157 A1
(43) Pub. Date: Sep. 16, 2021

(54) VEHICLE FOLLOWING TRAVELING SYSTEM, VEHICLE CONTROL APPARATUS, VEHICLE, AND CONTROL METHOD

(71) Applicant: HONDA MOTOR CO., LTD., Tokyo (JP)

(72) Inventors: Satoshi KOIKE, Wako-shi (JP); Ryuichi HATA, Wako-shi (JP); Naoyuki KUBO, Wako-shi (JP); Takayuki SAKATA, Wako-shi (JP); Masayasu YOSHIDA, Wako-shi (JP); Mitsuru NONAKA, Tokyo (JP); Seiichi KATO, Tokyo (JP); Masanori YOSHIHIRA, Wako-shi (JP)

(21) Appl. No.: 17/181,175

(22) Filed: Feb. 22, 2021

(30) Foreign Application Priority Data
Mar. 12, 2020 (JP) 2020-043266

(51) Int. Cl. B60W 30/165; B60W 30/095; B60Q 1/46

(52) U.S. Cl. CPC B60W 30/165; B60W 30/0956; B60Q 1/46; B60W 2555/20; B60W 2554/4046; B60W 2554/4044; B60W 2554/4026

(57) ABSTRACT

A vehicle following traveling system including a leading vehicle and a following vehicle is provided. The leading vehicle is a two-wheel vehicle. The following vehicle determines the possibility that the leading vehicle turns over or understeers; and performs control such that the following vehicle is caused to execute a risk aversion operation based on the determined possibility that the leading vehicle turns over or understeers.

### CROSS-REFERENCE TO RELATED APPLICATION(S)

This application claims priority to and the benefit of Japanese Patent Application No. 2020-043266 filed on Mar. 12, 2020, the entire disclosure of which is incorporated herein by reference.

### BACKGROUND OF THE INVENTION

### Field of the Invention

The present invention relates to a vehicle following traveling system, a vehicle control apparatus, a vehicle, and a control method.

### Description of the Related Art

A vehicle following traveling system is proposed for performing electronic towing traveling (following traveling) in which a following vehicle that can perform following traveling travels while being nonmechanically linked to a leading vehicle (followed vehicle) (Japanese Patent Laid-Open No. 2019-1227).

In such a system, in order to prevent another vehicle from cutting in between a leading vehicle and a following vehicle, the following vehicle keeps a short following distance from the leading vehicle. On the other hand, when the leading vehicle is a motorcycle, there are cases where the motorcycle turns over or understeers, and therefore, if the following distance is short, it is possible that the following vehicle comes into contact with the leading vehicle or an occupant of the leading vehicle.

### SUMMARY OF THE INVENTION

The present invention aims to provide, in a vehicle following traveling system, a technique of performing following traveling such that a following vehicle will not come into contact with a leading vehicle or an occupant of the leading vehicle.

According to the present invention, a vehicle following traveling system is provided that is a vehicle following traveling system including a leading vehicle and a following vehicle, wherein the leading vehicle is a two-wheel vehicle, and the following vehicle includes determination unit for determining the possibility that the leading vehicle turns over or understeers, and control unit for performing control such that the following vehicle is caused to execute a risk aversion operation based on the possibility that the leading vehicle turns over or understeers that is determined by the determination unit.

### BRIEF DESCRIPTION OF THE DRAWINGS

FIG. 1 is a side view of a vehicle following traveling system according to an embodiment.

FIG. 2 is a hardware block diagram of a following car according to the embodiment.

FIG. 3 is a software block diagram of the following car according to the embodiment.

FIG. 4 is a diagram illustrating an exemplary processing to be executed by a vehicle control apparatus according to the embodiment.

FIG. 5 is a diagram illustrating an exemplary processing to be executed by the vehicle control apparatus according to the embodiment.

FIG. 6 is a diagram illustrating an exemplary processing to be executed by the vehicle control apparatus according to the embodiment.

FIG. 7 is a diagram illustrating an exemplary processing to be executed by the vehicle control apparatus according to the embodiment.

FIG. 8 is a diagram illustrating a bank angle of a leading car according to the embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

(System Configuration)

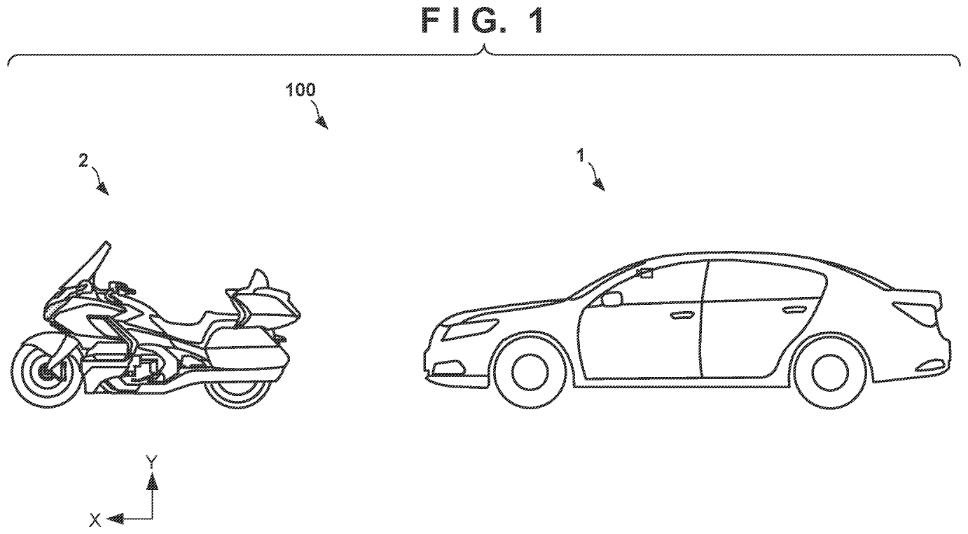

FIG. 1 is a side view of a vehicle following traveling system 100 according to the present embodiment, which includes a leading vehicle (leading car) 2 and a following vehicle (following car) 1. A description will be given assuming that, in FIG. 1, the leading car 2 is a two-wheel vehicle such as a motorcycle, and the following car 1 is a sedan type four-wheel passenger car, as an example. However, in the vehicle following traveling system 100, the leading car may be an automatic four-wheel vehicle, and the following vehicle may be a motorcycle.

In the present embodiment, a description will be given assuming that the leading car 2 is operated by an occupant, and provides a service for leading the following car 1 to a destination. In this specification, an event in which the occupant of the leading car 2 accepts to lead the following car 1, electronically links the following car 1 thereto, permits following, and performs traveling is called as “vehicle following traveling”. The state of being electronically linked refers to a state in which the information to be used for traveling of the following car 1 can be provided by the leading car 2 to the following car 1 at any time.

(Hardware Configuration)

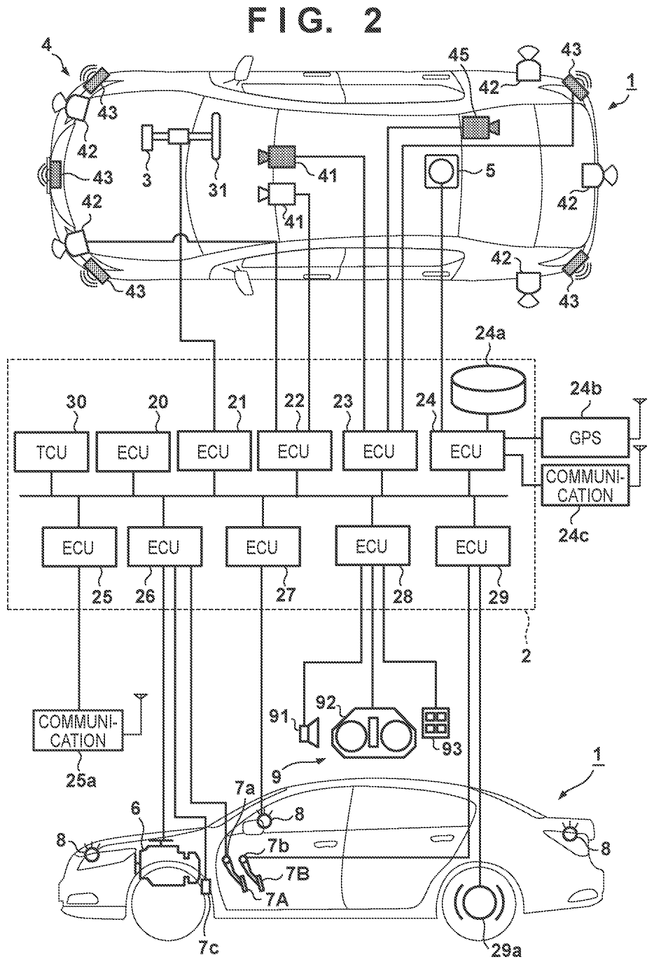

FIG. 2 is a block diagram of the following car 1 according to various embodiments of the present invention. In FIG. 2, the outline of the following car 1 is shown in plan view and side view. The following car 1 is a sedan type four-wheel passenger car, as an example. The following car 1 may be such a four-wheel vehicle, or may also be a two-wheel vehicle or another type of vehicle.

The following car 1 includes a vehicle control apparatus 10 (hereinafter, simply referred to as a “control apparatus 10”) for controlling the following car 1. The control apparatus 10 includes a plurality of ECUs 20 to 29 that are communicably connected by an in-vehicle network. Each ECU includes a processor represented by a CPU, a memory such as a semiconductor memory, an interface for an external device, and the like. The memory stores a program to be executed by the processor, data and the like to be used when the processor performs processing. Each ECU may include a plurality of processors, memories, interfaces, and the like. For example, the ECU 20 includes a processor 20a and a memory 20b. As a result of the processor 20a executing commands included in a program stored in the memory 20b, processing is executed by the ECU 20. Instead thereof, the ECU 20 may include a dedicated integrated circuit such as an ASIC for the ECU 20 to execute processing. The same applies to the other ECUs.

Hereinafter, the functions or the like to be performed by the respective ECUs 20 to 29 will be described. Note that the number of ECUs and the functions performed by the respective ECUs can be appropriately designed, and the number thereof can be increased than that of the present embodiment, or reduced by integration.

The ECU 20 executes control relating to automated driving of the following car 1. In the automated driving, at least one of steering and speed of the following car 1 is automatically controlled.

The ECU 21 controls an electric power steering apparatus 3. The electric power steering apparatus 3 includes a mechanism for steering front wheels according to a driving operation (steering operation) performed on a steering wheel 31 by the driver. Also, the electric power steering apparatus 3 includes a motor for exerting a driving force for assisting the steering operation and automatically steering the front wheels, and a sensor for detecting the steering angle, and the like. When the driving state of the following car 1 is the automated driving, the ECU 21 controls the running direction of the following car 1 by automatically controlling the electric power steering apparatus 3 according to the instructions from the ECU 20.

The ECUs 22 and 23 control detection units 41 to 43 for detecting conditions around the vehicle, and perform information processing on detection results. The detection units 41 (hereinafter, may also be denoted as cameras 41) are cameras that capture an image forward of the following vehicle 1, and is installed at a roof front part and on an interior side of the front window of the following vehicle 1, in the present embodiment. The contour of an object and lane markings (such as white lines) on a road can be extracted by analyzing images captured by the cameras 41.

Detection units 42 are LIDARs (Light Detection and Ranging) (hereinafter, may also be denoted as LIDARs 42), and detect an object around the following car 1, and measure the distance to the object. In the case of the present embodiment, five LIDARs 42 are provided, namely one each at front corners of the following car 1, one at the rear center, and one each at rear side faces thereof. Detection units 43 (hereinafter, may also be denoted as radars 43) are millimeter wave radars, and detect an object around the following car 1, and measure the distance to the object. In the case of the present embodiment, five radars 43 are provided, namely one at the front center of the vehicle 1, one each at the front corners, and one each at rear corners.

The ECU 22 controls one of the cameras 41 and the LIDARs 42, and performs information processing on detection results. The ECU 23 controls the other camera 41 and the radars 43, and performs information processing on detection results. As a result of including two sets of apparatuses for detecting conditions around the vehicle, the reliability of the detection result can be improved, and as a result of including different types of detection units such as cameras, LIDARs. and radars, the surrounding environment of the vehicle can be analyzed in a multifaceted manner.

The ECU 24 controls a gyrosensor 5, a GPS sensor 24b, and a communication apparatus 24c, and performs information processing on detection results and communication results. The gyrosensor 5 detects the rotational motion of the following car 1. The course of the following car 1 can be determined based on the detection result of the gyrosensor 5, wheel speed, and the like. The GPS sensor 24b detects the current position of the following car 1. The communication apparatus 24c performs wireless communication with a server that provides map information, traffic information, and weather information, and acquires these pieces of information. The ECU 24 can access a database 24a of the map information constructed in a memory, and searches the route from the current place to a destination, and the like. The ECU 24, map database 24a, and GPS sensor 24b configure a so-called navigation apparatus.

The ECU 25 includes a communication apparatus 25a for inter-vehicle communication. The communication apparatus 25a performs wireless communication with other vehicles around the following car 1, and exchanges information between vehicles. A TCU (Telematics Control Unit) 30 performs communication with a network using a cellular network. Also, the TCU 30 may perform communication with Wi-Fi (registered trademark), DSRC (Dedicated Short Range Communications), or the like.

The ECU 26 controls a power plant 6. The power plant 6 is a mechanism that outputs a driving force for rotating driving wheels of the following car 1, and includes an engine and a transmission, for example. The ECU 26 controls the engine output according to a driving operation (accelerator pedal operation or acceleration operation) made by the driver that has been detected by an operation detection sensor 7a provided in an accelerator pedal 7A, and switches the gear ratio of the transmission based on information such as vehicle speed detected by a vehicle speed sensor 7c, for example. When the driving state of the following car 1 is the automated driving, the ECU 26 automatically controls the power plant 6, and controls acceleration and deceleration of the following car 1, according to the instruction from the ECU 20.

The ECU 27 controls lighting devices (such as headlight and taillight) including direction indicators 8 (winkers). In the case of the example in FIG. 2, the direction indicators 8 are provided at the front and rear of the following car 1 and at door mirrors.

The ECU 28 controls an input/output apparatus 9. The input/output apparatus 9 outputs information to the driver, and receives information from the driver. An audio output apparatus 91 notifies the driver of information by sound. The display apparatus 92 notifies the driver of information by displaying an image. The display apparatus 92 is arranged in front of a driving seat, for example, and constitutes an instrument panel or the like. Note that sound and display are illustrated here, but the driver may be notified of information using vibration or light. Also, the driver may be notified of information by combining two or more of sound, display, vibration, and light. Moreover, the combination or the reporting mode may be changed in accordance with the level of information (degree of urgency, for example) to be notified of. The input device 93 is arranged at a position such that the driver can operate, and is a switch group for giving instructions to the following car 1, and may also include a voice input apparatus.

The ECU 29 controls braking apparatuses 29a and a parking brake (not illustrated). The braking apparatuses 29a are disc brake apparatuses, for example, and provided at respective wheels of the following car 1 in order to decelerate or stop the following car 1 by applying resistance to the rotation of the wheels. The ECU 29 controls the operation of the braking apparatuses 29a according to the driving operation (brake operation) made by the driver that is detected by an operation detection sensor 7b provided at a brake pedal 7B, for example. When the driving state of the following car 1 is automated driving, the ECU 29 controls deceleration or stopping of the following car 1 by automatically controlling the braking apparatuses 29a according to the instruction from the ECU 20. The braking apparatuses 29a and the parking brake can be operated to keep the following car 1 at a stopped state. Also, if the transmission of the power plant 6 includes a parking lock mechanism, this mechanism can be operated to keep the following car 1 at a stopped state.

(Software Configuration)

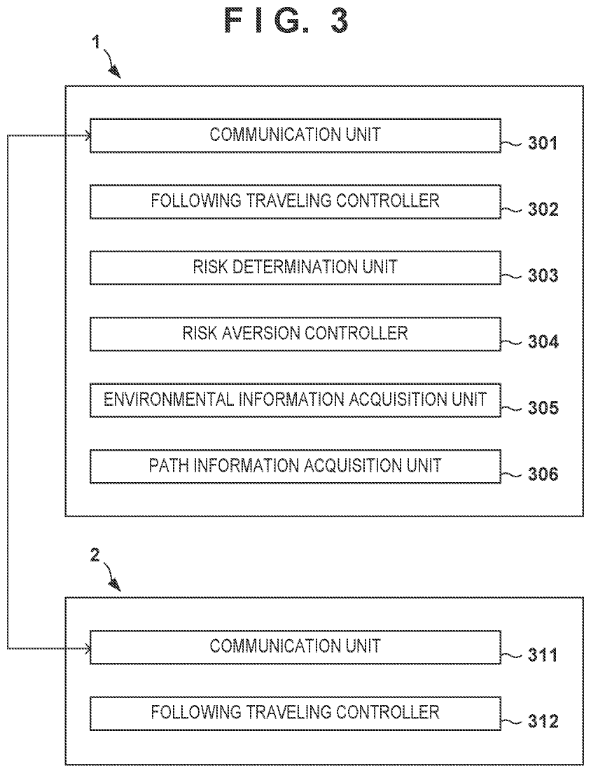

Next, the software configuration of the vehicle following traveling system 100 according to the present embodiment will be described with reference to FIG. 3.

The following car 1 includes, as shown in FIG. 3, a communication unit 301, a following traveling controller 302, a risk determination unit 303, a risk aversion controller 304, an environmental information acquisition unit 305, and a path information acquisition unit 306. The following traveling controller 302 acquires, via the communication unit 301 that performs communication with the leading car 2 via the communication apparatus 25a, information (hereinafter, called as “traveling information”) regarding traveling of the leading vehicle such as amounts of operations made by the driver on the accelerator pedal, brake pedal, and steering wheel of the leading vehicle, and vehicle speed detected by a vehicle speed sensor. The following car 1 performs following traveling while securing a following distance by using the acquired traveling information for following traveling control.

The risk determination unit 303 determines whether or not the leading car 2 has a risk of turn-over, sudden stop, or understeer (deviation from a lane). In one example, it is determined whether or not the possibility of turn-over or sudden stop is higher than a predetermined value. If the risk determination unit 303 has determined that there is a risk of turn-over, sudden stop, or understeer, the risk aversion controller 304 performs risk aversion in order to prevent contact with the leading car 2 or deviation from the lane. The risk aversion includes deceleration or stopping by operating the braking device 29a, or evacuation to a road shoulder, as will be described later. The environmental information acquisition unit 305 acquires output data of at least one of the detection units 41 to 43. The path information acquisition unit 306 acquires information regarding a path on which the leading car 2 is scheduled to travel, from the map database 24a. In one example, the path information acquisition unit 306 may acquire information regarding the scheduled traveling path from the leading car 2 via the communication apparatus 25a or the TCU 30.

The leading car 2 includes a communication unit 311 and a following traveling controller 312. The following traveling controller 312 collects traveling information of the leading car 2. The following traveling controller 312 generates information (hereinafter, called as “leading information”) to be used by the following car 1 to follow the leading car 2 based on the traveling information, and provides the leading information to the following car 1 via the communication unit 311. The communication between the communication unit 311 of the leading car 2 and the communication apparatus 25a of the following car 1 may be performed by inter-vehicle communication. A description will be given assuming that the traveling of the leading car 2 that is leading the following car 1 is performed by manual driving, but the traveling of the leading car 2 may be performed by automated driving. In this case, the leading car 2 also includes the configuration for automated driving described with reference to FIG. 2. The following traveling controller 312 may be realized by the ECU 20 that executes control relating to the automated driving. Instead thereof (when the leading car 2 does not have an automated driving function, for example), the following traveling controller 312 may also be realized by another ECU.

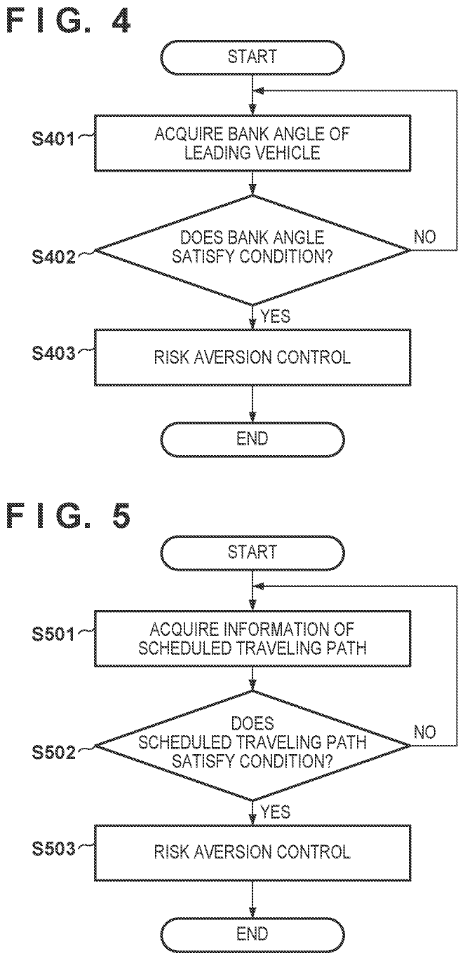

Next, the risk aversion control processing to be executed by the control apparatus 10 of the following car 1 will be described with reference to FIGS. 4 to 7. A description will be given assuming that the processing in FIGS. 4 to 7 is realized by the processor of the ECU 20 relating to the automated driving of the vehicle control apparatus 10 executing a program stored in a storage unit. Note that, in one example, the processing may be executed in cooperation with at least one of the other ECUs 21 to 29 of the vehicle control apparatus 10. Also, some parts of processing in FIGS. 4 to 7 may be executed by a plurality of ECUs, among the ECU 20 to 29, of the vehicle control apparatus 10. The processing in FIGS. 4 to 7 is started when the vehicle following traveling is started, that is, when the following car 1 starts traveling behind the leading car 2.

### Processing Example 1

FIG. 4 illustrates processing for performing risk aversion based on the bank angle of the leading car 2.

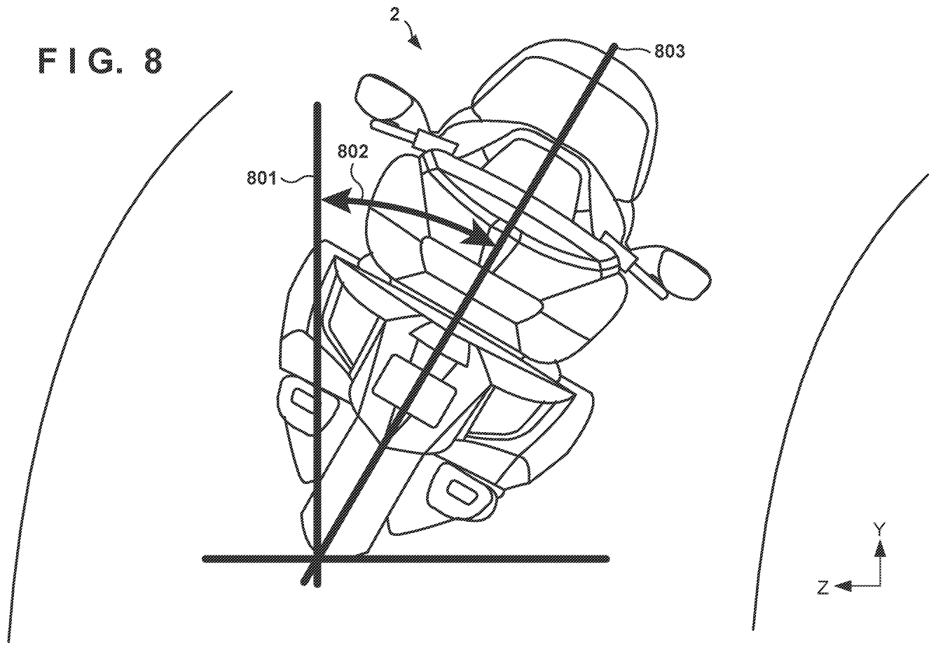

First, in step S401, vehicle control apparatus 10 acquires the bank angle of the leading car 2. Here, the bank angle will be described with reference to FIG. 8. FIG. 8 shows an example of a captured image captured by a shooting apparatus 41 of the following car 1. In FIG. 8, the driver of the leading car 2 is not displayed for making the description easy. The inclination of a vehicle body 803 of the leading car 2 relative to the vertical direction 801 on which the leading car 2 travels is the bank angle 802. Therefore, the shooting apparatus 41 may calculate the bank angle 802 from the inclination of the rear wheel of the leading car 2. In another example, the bank angle 802 may be calculated by specifying an axis 803 of the vehicle body based on any marker such as a number plate or a handle.

Also, in step S401, when the leading car 2 includes a geomagnetic sensor or an inclination angle sensor for specifying the bank angle, the vehicle control apparatus 10 may acquire the bank angle of the leading car 2 by acquiring data indicating the bank angle as the traveling information from the leading car 2 via the communication unit 301.

Next, the vehicle control apparatus 10 advances the processing to step S402, and determines whether or not the bank angle of the leading car 2 satisfies a predetermined condition. For example, the predetermined condition may be a condition that the bank angle is 40 degrees or more. With this, the vehicle control apparatus 10 can detect that the possibility that the leading car 2 turns over is high before the leading car 2 turns over.

Note that, in step S402, the vehicle control apparatus 10 may determine whether or not a predetermined condition is satisfied based on the vehicle speed of the leading car 2 included in the traveling information in addition to the bank angle of the leading car 2. In this case, the predetermined condition may be a condition that the vehicle speed is 60 km or less and the bank angle is 40 degrees or more, or a condition that the vehicle speed is 60 km or more and the bank angle is 45 degrees or more. In this way, the condition of the bank angle for determining whether or not the risk aversion control is executed can be set for each vehicle speed.

If it is determined that the bank angle of the leading car 2 does not satisfy the predetermined condition (No in step S402), the vehicle control apparatus 10 returns the processing to step S401, and again acquires the bank angle of the leading car 2. If it is determined that the bank angle of the leading car 2 satisfies the predetermined condition (Yes in step S402), the vehicle control apparatus 10 advances the processing to step S403, and executes the risk aversion control. For example, the vehicle control apparatus 10 causes the braking device 29a to operate, and decreases the vehicle speed of the following car 1. Accordingly, the vehicle can be controlled such that the risk that the leading car 2 that has turned over or the occupant of the leading car 2 comes into contact with the following car 1 can be averted.

Note that, in step S403, the following car 1 may, in addition to causing the braking device 29a to operate, cause the tail lamp (indicator) to be turned on or flash, for example. With this, a vehicle following the following car 1 can be given a visual warning. Also, in step S403, the following car 1 may give a warning to a vehicle following the following car 1 with sound by sounding the horn. With this, the possibility that the vehicle following the following car 1 comes into contact with the leading car 2 or the occupant of the leading car 2 can be reduced.

### Processing Example 2

FIG. 5 shows processing to be performed by the vehicle control apparatus 10 for performing risk aversion based on information regarding the scheduled traveling path of the leading car 2.

First, in step S501, the vehicle control apparatus 10 acquires map data regarding the surrounding area of the scheduled traveling path of the leading car 2 from the map database 24a. Next, the vehicle control apparatus 10 advances the processing to step S502, and determines whether or not the scheduled traveling path satisfies a predetermined condition. For example, the predetermined condition includes a condition that a path (sharp curve) whose curvature R is 50 or less is included in the scheduled traveling path, and the distance until the path is 100 m or less. When traveling along a sharp curve path in this way, the possibility that the leading car 2 turns over or understeers in a predetermined period of time may increase compared with a case where traveling is performed along a straight-line path. Therefore, the vehicle control apparatus 10 determines that the scheduled traveling path satisfies the predetermined condition (Yes in step S502), advances the processing to step S503, and executes risk aversion processing so as to increase the distance from the leading car 2. With this, even in a case where the leading car 2 turns over or understeers when the leading car 2 passes through a sharp curve, the possibility that the following car 1 comes into contact with the leading car 2 or the occupant of the leading car 2 can be reduced.

Also, in one example, the predetermined condition regarding the scheduled traveling path may also be a condition that a road structure such as a manhole is present on the scheduled traveling path. For example, when a manhole is present on the scheduled traveling path, it is possible that the leading car 2 slips on the manhole and turns over. Therefore, the vehicle control apparatus 10 can reduce the possibility that the following car 1 comes into contact with the leading car 2 or the occupant of the leading car 2 even if the leading car 2 turns over due to a road structure, by increasing the distance between the leading car 2 and the following car 1 in advance.

### Processing Example 3

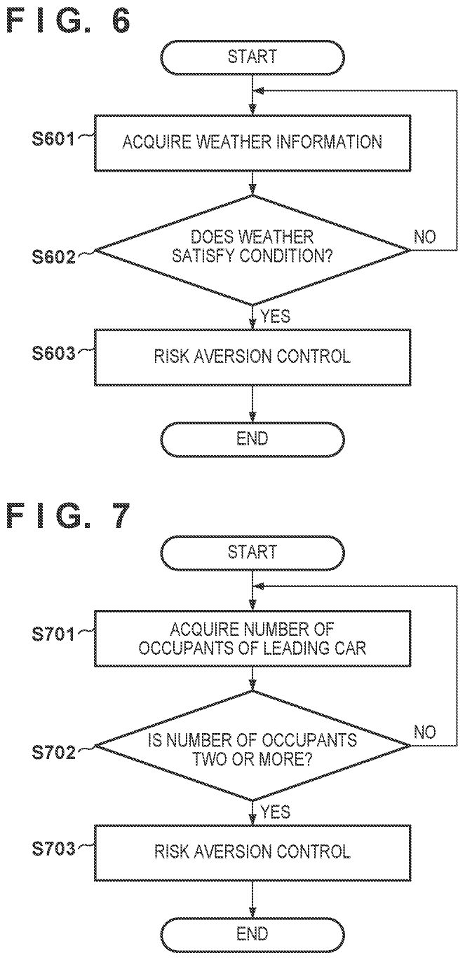

FIG. 6 shows an example of processing performed by the vehicle control apparatus 10 to perform risk aversion based on information regarding the weather around the leading car 2.

First, in step S601, the vehicle control apparatus 10 determines the weather in the vicinity from the output data of the detection units 41 to 43. For example, the fact that it is raining can be detected from the state of a road surface portion in an image that is captured by an image capture apparatus 41. Also, the fact that it is raining may be detected based on the signal strength of reflected signals of the LIDARs 42 or radars 43, for example. Alternatively, the fact that it is raining may be detected based on the output of a raindrop detection sensor (not illustrated) included in the following car 1. Also, the current weather information regarding the current place may be acquired by accessing an external apparatus via a wide area network from the communication apparatus 24c, and transmitting information regarding the current place acquired from the GPS sensor 24b.

Next, the vehicle control apparatus 10 advances the processing to step S602, and determines whether or not the weather at the current place satisfies a predetermined condition. In one example, the predetermined condition includes a condition that the weather at the current place is rainy weather or snowing, and the road surface is wet. In this case, the possibility that the leading car 2 slips and turns over as a result of the driver of the leading car 2 being unable to control the leading car 2 increases compared with the case w % here the road surface is dry. Therefore, the vehicle control apparatus 10 advances the processing to step S603, and increases the distance between the leading car 2 and the following car 1 before the leading car 2 turns over. With this, even if the leading car 2 has turned over due to bad road surface condition, the possibility that the following car 1 comes into contact with the leading car 2 or the occupant of the leading car 2 can be reduced.

### Processing Example 4

FIG. 7 shows an example of processing to be performed by the vehicle control apparatus 10 to perform risk aversion based on information regarding the number of occupants of the leading car 2.

First, in step S701, the vehicle control apparatus 10 acquires information indicating the number of occupants of the leading car 2. The leading car 2 may specify the number of occupants of the leading car 2 based on the outputs of seating sensors installed in the seats of the leading car 2, and the vehicle control apparatus 10 may acquire the information indicating the number of occupants via the communication apparatus 25a. In another example, the vehicle control apparatus 10 may specify the number of occupants of the leading car 2 by applying image analysis on image data of the leading car 2 obtained by shooting performed by the front camera 41, and performing human detection.

Next, the vehicle control apparatus 10 advances the processing to step S702, and determines whether or not the number of occupants is two or more. If the number of occupants of the leading car 2, which is a motorcycle, is two or more, the driver of the leading car 2 has operation feeling different from that of the case of operating the leading car 2 without other occupants, and the possibility that the leading car 2 turns over or understeers may increase. Therefore, the vehicle control apparatus 10 advances the processing to step S703, and increases the distance between the leading car 2 and the following car 1 before the leading car 2 turns over or understeers. With this, even if the leading car 2 turns over due to two or more occupants being present, the possibility that the following car 1 comes into contact with at least one of the leading car 2 and the occupants of the leading car 2 can be reduced.

### Other Embodiments

In one example, the configuration may be such that, by combining the processing examples 1 to 4, the risk factor is calculated from information regarding at least one of the bank angle of the leading car 2, the scheduled traveling path, the weather in the vicinity, and the number of occupants, and it is determined whether or not the risk factor is a predetermined value or more. For example, it may be defined such that the risk factor that turn-over or understeering occurs increases by 30 if the bank angle is 15 degrees or more, and the risk factor that turn-over or understeering occurs increases by 20 if the scheduled traveling path is a curve of R=100 or less. Also, if the sum of a plurality of risk factors is 60 or more, the risk aversion operation may be executed, considering that the possibility of turn-over is high. Accordingly, the possibility that turn-over or understeering occurs due to complex factors can be evaluated. Note that the description has been given assuming that the risk factors can be added, but in one example, the risk factors may be multiplied. For example, the configuration may be such that the basic risk factor is set to 50, and if the bank angle is 15 degrees or more, the risk factor is multiplied by 1.1, and if the weather in the vicinity is raining, the risk factor is multiplied by 1.2. Also, the vehicle control apparatus 10 may be configured such that the risk factor is multiplied by 1.4 if the number of occupants is two or more, and if the ultimate risk factor obtained by multiplications is 80 or more, for example, the risk aversion operation is executed.

Also, the following distance may be set according to the risk factor. For example, the configuration may be such that, if the risk factor is 50 to 60, the following distance is set to 10 m, if the risk factor is 60 to 80, the following distance is set to 20 m, and if the risk factor is 80 or more, the following distance is set to 30 m. Accordingly, an appropriate following distance can be set according to the degree of possibility that turn-over or understeering occurs.

### Summary of Embodiments

1. The vehicle following traveling system (e.g., 100) according to the aforementioned embodiment is a vehicle following traveling system including a leading vehicle (e.g., 2) and a following vehicle (e.g., 1), wherein the leading vehicle is a two-wheel vehicle, and the following vehicle includes determination unit (e.g., 303) for determining the possibility that the leading vehicle turns over or understeers, and control unit (e.g., 304) for performing control such that the following vehicle is caused to execute a risk aversion operation based on the possibility that the leading vehicle turns over or understeers that is determined by the determination unit.

Accordingly, in the vehicle following traveling system, it is possible to perform following traveling such that the following vehicle will not come into contact with the leading vehicle or an occupant of the leading vehicle.

2. In the vehicle following traveling system according to the aforementioned embodiment, the following vehicle further includes first acquisition unit for acquiring a bank angle of the leading vehicle (e.g., step S401), and the determination unit determines the possibility that the leading vehicle turns over or understeers based on the bank angle of the leading vehicle acquired by the first acquisition unit.

Accordingly, in the vehicle following traveling system, it is possible to perform following traveling such that the following vehicle will not come into contact with the leading vehicle or an occupant of the leading vehicle, according to the bank angle of the leading vehicle.

3. In the vehicle following traveling system according to the aforementioned embodiment, the leading vehicle includes first providing unit for providing a bank angle acquired based on an output of a sensor to the following vehicle via a communication unit, and the first acquisition unit acquires the bank angle of the leading vehicle from the leading vehicle via a communication unit.

Accordingly, it is possible to perform following traveling such that the following vehicle will not come into contact with the leading vehicle or an occupant of the leading vehicle, based on the bank angle provided by the leading vehicle.

4. In the vehicle following traveling system according to the aforementioned embodiment, the first acquisition unit calculates the bank angle of the leading vehicle based on data obtained by shooting performed by a camera that shoots a forward area of the following vehicle.

Accordingly, even in a case where information regarding the bank angle is not provided by the leading vehicle, it is possible to perform following traveling such that the following vehicle will not come into contact with the leading vehicle or an occupant of the leading vehicle, according to the bank angle of the leading vehicle.

5. In the vehicle following traveling system according to the aforementioned embodiment, the following vehicle further includes second acquisition unit for acquiring the number of occupants of the leading vehicle (e.g., step S701), and the determination unit determines the possibility that the leading vehicle turns over or understeers based on the number of occupants of the leading vehicle acquired by the second acquisition unit.

Accordingly, in the vehicle following traveling system, it is possible to perform following traveling such that the following vehicle will not come into contact with the leading vehicle or an occupant of the leading vehicle, according to the number of occupants of the leading vehicle.

6. In the vehicle following traveling system according to the aforementioned embodiment, the leading vehicle includes a second providing unit for providing the number of occupants acquired based on an output of a seating sensor to the following vehicle via a communication unit, and the second acquisition unit acquires the number of occupants of the leading vehicle from the leading vehicle via a communication unit.

Accordingly, it is possible to perform following traveling such that the following vehicle will not come into contact with the leading vehicle or an occupant of the leading vehicle, based on the number of occupants provided by the leading vehicle.

7. In the vehicle following traveling system according to the aforementioned embodiment, the second acquisition unit specifies the number of occupants of the leading vehicle based on data obtained by shooting performed by a camera that shoots a forward area of the following vehicle.

Accordingly, even in a case where information regarding the number of occupants is not provided by the leading vehicle, it is possible to perform following traveling such that the following vehicle will not come into contact with the leading vehicle or an occupant of the leading vehicle, based on the number of occupants provided by the leading vehicle.

8. In the vehicle following traveling system according to the aforementioned embodiment, the following vehicle further includes third acquisition unit for acquiring a scheduled traveling path (e.g., step S501), the determination unit determines the possibility that the leading vehicle turns over or understeers based on a parameter of the path acquired by the third acquisition unit.

Accordingly, it is possible to perform following traveling such that the following vehicle will not come into contact with the leading vehicle or an occupant of the leading vehicle, based on the scheduled traveling path of the leading vehicle.

9. In the vehicle following traveling system according to the aforementioned embodiment, the determination unit determines the possibility that the leading vehicle turns over or understeers based on the curvature of a path acquired by the third acquisition unit.

Accordingly, even in a case where the scheduled traveling path of the leading vehicle includes a path having a large curvature, it is possible to perform following traveling such that the following vehicle will not come into contact with the leading vehicle or an occupant of the leading vehicle.

10. In the vehicle following traveling system according to the aforementioned embodiment, the determination unit determines the possibility that the leading vehicle turns over or understeers based on a road structure on a path acquired by the third acquisition unit.

Accordingly, even in a case where a road structure is present due to which the possibility that the leading vehicle turns over or understeers is high, it is possible to perform following traveling such that the following vehicle will not come into contact with the leading vehicle or an occupant of the leading vehicle.

11. In the vehicle following traveling system according to the aforementioned embodiment, the following vehicle further includes detection unit for detecting rain, fog, a snowfall, and a strong wind in the vicinity of the following vehicle (step S601), and the determination unit determines the possibility that the leading vehicle turns over or understeers based on the detection unit having detected rain, fog, a snowfall, or a strong wind in the vicinity of the following vehicle.

Accordingly, even in a case where the possibility that the leading vehicle turns over or understeers is high due to weather in the vicinity, it is possible to perform following traveling such that the following vehicle will not come into contact with the leading vehicle or an occupant of the leading vehicle.

12. In the vehicle following traveling system according to the aforementioned embodiment, the risk aversion operation includes at least one of increasing a following distance between the leading vehicle and the following vehicle and performing braking of a wheel of the following vehicle.

Accordingly, as a result of increasing the following distance or performing braking of a wheel, it is possible to perform following traveling such that the following vehicle will not come into contact with the leading vehicle or an occupant of the leading vehicle.

13. In the vehicle following traveling system according to the aforementioned embodiment, the control unit makes notification to a traffic participant behind the following vehicle, when causing the following vehicle to execute the risk aversion operation.

Accordingly, notification can be performed such that not only the following vehicle but a vehicle following the following vehicle will not come into contact with the leading vehicle or an occupant of the leading vehicle.

14. In the vehicle following traveling system according to the aforementioned embodiment, the control unit makes the notification by causing a tail lamp to be turned on or flash.

Accordingly, visual notification can be performed to a vehicle following the following vehicle.

15. The vehicle following traveling system according to the aforementioned embodiment is a vehicle control apparatus (e.g., 10) of a vehicle (e.g., 1) that can follow a leading vehicle (e.g., 2) in a vehicle following traveling system (e.g., 100), and includes determination unit for determining the possibility that the leading vehicle turns over or understeers, and control unit for performing control such that the vehicle is caused to execute a risk aversion operation based on the possibility that the leading vehicle turns over or understeers that is determined by the determination unit.

Accordingly, it is possible to control the following vehicle so as to perform following traveling such that the following vehicle will not come into contact with the leading vehicle or an occupant of the leading vehicle, in the vehicle following traveling system.

16. The vehicle according to the aforementioned embodiment is a vehicle (e.g., 1) that can follow a leading vehicle (e.g., 2), in a vehicle following traveling system (e.g., 100), and includes determination unit for determining the possibility that the leading vehicle turns over or understeers, and control unit for performing control such that the vehicle is caused to execute a risk aversion operation based on the possibility that the leading vehicle turns over or understeers that is determined by the determination unit.

Accordingly, it is possible to perform following traveling such that the following vehicle will not come into contact with the leading vehicle or an occupant of the leading vehicle, in the vehicle following traveling system.

17. The control method according to the aforementioned embodiment is a control method of a control apparatus (e.g., 10) of a vehicle (e.g., 1) that can follow a leading vehicle (e.g., 2), in a vehicle following traveling system (e.g., 100), and includes a determination step (e.g., step S402) of determining the possibility that the leading vehicle turns over or understeers, and a control step (e.g., step S403) of performing control such that the vehicle is caused to execute a risk aversion operation based on the possibility that the leading vehicle turns over or understeers that is determined by the determination unit.

Accordingly, it is possible to perform following traveling such that the following vehicle will not come into contact with the leading vehicle or an occupant of the leading vehicle, in the vehicle following traveling system.

What is claimed is:

1. A vehicle following traveling system including a leading vehicle and a following vehicle,
wherein the leading vehicle is a two-wheel vehicle,
the following vehicle executes a control method, and
the control method includes:
determining the possibility that the leading vehicle turns over or understeers; and
performing control such that the following vehicle is caused to execute a risk aversion operation based on the determined possibility that the leading vehicle turns over or understeers.

2. The vehicle following traveling system according to claim 1,
wherein the control method further includes: acquiring a bank angle of the leading vehicle, and
the determining includes determining the possibility that the leading vehicle turns over or understeers based on the acquired bank angle of the leading vehicle.

3. The vehicle following traveling system according to claim 2,
wherein the leading vehicle provides a bank angle acquired based on an output of a sensor to the following vehicle via a communication unit, and
the acquiring of a bank angle of the leading vehicle includes acquiring the bank angle of the leading vehicle from the leading vehicle via a communication unit.

4. The vehicle following traveling system according to claim 2,
wherein the acquiring of a bank angle of the leading vehicle includes calculating the bank angle of the leading vehicle based on data obtained by shooting performed by a camera that shoots a forward area of the following vehicle.

5. The vehicle following traveling system according to claim 1,
wherein the control method further includes acquiring the number of occupants of the leading vehicle, and
the determining includes determining the possibility that the leading vehicle turns over or understeers based on the acquired number of occupants of the leading vehicle.

6. The vehicle following traveling system according to claim 5,
wherein the leading vehicle provides the number of occupants acquired based on an output of a seating sensor to the following vehicle via a communication unit, and
the acquiring the number of occupants of the leading vehicle includes acquiring the number of occupants of the leading vehicle from the leading vehicle via a communication unit.

7. The vehicle following traveling system according to claim 5,
wherein the acquiring the number of occupants of the leading vehicle includes specifying the number of occupants of the leading vehicle based on data obtained by shooting performed by a camera that shoots a forward area of the following vehicle.

8. The vehicle following traveling system according to claim 1,
wherein the control method further includes: acquiring a scheduled traveling path, and
the determining includes determining the possibility that the leading vehicle turns over or understeers based on an acquired parameter of the scheduled traveling path.

9. The vehicle following traveling system according to claim 8,
wherein the determining includes determining the possibility that the leading vehicle turns over or understeers based on the curvature of the acquired scheduled traveling path.

10. The vehicle following traveling system according to claim 8,
wherein the determining includes determining the possibility that the leading vehicle turns over or understeers based on a road structure on the acquired scheduled traveling path.

11. The vehicle following traveling system according to claim 1,
wherein the control method further includes: detecting rain, fog, a snowfall, and a strong wind in the vicinity of the following vehicle, and
the determining includes determining the possibility that the leading vehicle turns over or understeers based on having detected rain, fog, a snowfall, or a strong wind in the vicinity of the following vehicle.

12. The vehicle following traveling system according to claim 1,
wherein the risk aversion operation includes at least one of increasing a following distance between the leading vehicle and the following vehicle and performing braking of a wheel of the following vehicle.

13. The vehicle following traveling system according to claim 1,
wherein the performing control such that the following vehicle is caused to execute a risk aversion operation includes making notification to a traffic participant behind the following vehicle, when causing the following vehicle to execute the risk aversion operation.

14. The vehicle following traveling system according to claim 13,
wherein the making notification includes causing a tail lamp to be turned on or flash.

15. A vehicle control apparatus of a vehicle that can follow a leading vehicle in a vehicle following traveling system, the vehicle control apparatus executing a control method,
wherein the control method includes:
determining the possibility that the leading vehicle turns over or understeers; and
performing control such that the following vehicle is caused to execute a risk aversion operation based on the determined possibility that the leading vehicle turns over or understeers.

16. A vehicle that can follow a leading vehicle in a vehicle following traveling system, the vehicle executing a control method,
wherein the control method includes:
determining the possibility that the leading vehicle turns over or understeers; and
performing control such that the following vehicle is caused to execute a risk aversion operation based on the determined possibility that the leading vehicle turns over or understeers.

17. A control method of a control apparatus of a vehicle that can follow a leading vehicle in a vehicle following traveling system, the control method comprising:
determining the possibility that the leading vehicle turns over or understeers; and
performing control such that the following vehicle is caused to execute a risk aversion operation based on the determined possibility that the leading vehicle turns over or understeers.
